(19) United States
(12) Patent Application Publication
(10) Pub. No.: US 2024/0313902 A1
(43) Pub. Date: Sep. 19, 2024

(54) METHODS FOR COMMUNICATIONS, TERMINAL DEVICE, NETWORK DEVICE AND COMPUTER READABLE MEDIA

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/575,526

(22) PCT Filed: Jun. 30, 2021
(86) PCT No.: PCT/CN2021/103769

§ 371 Date: Dec. 29, 2023

(51) Int. Cl. H04L 1/1829; H04L 1/1867; H04W 72/232; H04W 72/40

(52) U.S. Cl. CPC H04L 1/1854; H04L 1/1896; H04W 72/232; H04W 72/40

(57) ABSTRACT

Embodiments of the present disclosure provide a solution for transmitting Hybrid Automatic Repeat Request (HARQ) feedback. A method for communications comprises transmitting, from a terminal device to a network device, at least one HARQ-ACK codebook in a slot. The at least one HARQ-ACK codebook comprises a first feedback for unicast service and a second feedback for Multicast and Broadcast Service (MBS).

### FIELD

Embodiments of the present disclosure generally relate to the field of communication, and in particular, to a solution for transmitting Hybrid Automatic Repeat Request (HARQ) feedback.

### BACKGROUND

To improve transmission reliability, a HARQ mechanism has been widely used in communication systems. In HARQ, a receiver feeds back a positive acknowledgement (ACK) to a transmitter if data from the transmitter is detected correctly, and a negative acknowledgement (NACK) if the data is not correctly detected. Then, a transmitter performs a new transmission or a retransmission depending on whether an ACK or NACK is received from the receiver.

In Release 15 and 16, when a terminal device determines to construct a HARQ-ACK codebook, the current specification only consider the unicast service whereas downlink (DL) transmission occasion for Multicast and Broadcast Service (MBS) cannot be contained as the current specification does not support MBS. In Release 17, since the mechanism to improve the reliability for terminal devices in a connected mode is one of work items of NR MBS, it is urgent to complete the HARQ-ACK feedback mechanism for support MBS.

### SUMMARY

In general, example embodiments of the present disclosure provide a solution for transmitting HARQ feedback.

In a first aspect, there is provided a method for communications. The method comprises transmitting, from a terminal device to a network device, at least one HARQ-ACK codebook in a slot. The at least one HARQ-ACK codebook comprises a first feedback for unicast service and a second feedback for MBS.

In a second aspect, there is provided a method for communications. The method comprises receiving, at a network device and from a terminal device, at least one HARQ-ACK codebook in a slot. The at least one HARQ-ACK codebook comprises a first feedback for unicast service and a second feedback for MBS.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a network device. The network device comprises a processor and a memory storing instructions. The memory and the instructions are configured, with the processor, to cause the network device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication network in which some embodiments of the present disclosure can be implemented;

FIG. 2 illustrates an example signaling chart showing an example process for transmitting HARQ feedback in accordance with some embodiments of the present disclosure;

FIG. 3 illustrates a simplified block diagram of an example process for transmitting HARQ feedback in accordance with some embodiments of the present disclosure;

FIG. 4 illustrates a simplified block diagram of an example process for transmitting HARQ feedback in accordance with some other embodiments of the present disclosure;

FIG. 5 illustrates a simplified block diagram of an example process for transmitting HARQ feedback in accordance with still other embodiments of the present disclosure;

FIG. 6 illustrates a simplified block diagram of an example process for transmitting HARQ feedback in accordance with still other embodiments of the present disclosure;

FIG. 7 illustrates a flowchart of an example method in accordance with some embodiments of the present disclosure;

FIG. 8 illustrates a flowchart of another example method in accordance with some embodiments of the present disclosure; and

FIG. 9 is a simplified block diagram of a device that is suitable for implementing some embodiments of the present disclosure.

Throughout the drawings, the same or similar reference numerals represent the same or similar elements.

### DETAILED DESCRIPTION OF EMBODIMENTS

Principles of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can perform communications. Examples of a network device include, but not limited to, a Node B (NodeB or NB), an Evolved NodeB (eNodeB or eNB), a next generation NodeB (gNB), an infrastructure device for a V2X communication, a Transmission/Reception Point (TRP), a Remote Radio Unit (RRU), a radio head (RH), a remote radio head (RRH), a low power node such as a femto node, a pico node, and the like.

As used herein, the term “terminal device” refers to any device having wireless or wired communication capabilities. Examples of the terminal device include, but not limited to, user equipment (UE), vehicle-mounted terminal devices, devices of pedestrians, roadside units, personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, some embodiments will be described with reference to UEs as examples of terminal devices and the terms “terminal device” and “user equipment” (UE) may be used interchangeably in the context of the present disclosure.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In Release 17, MBS is introduced. Thus, in Release 17, it should define a new method to construct a HARQ-ACK codebook when DL transmission for unicast and DL transmission for the MBS exist in a same DL slot and the corresponding HARQ-ACKs bit are scheduled in a same uplink (UL) slot.

Several solutions were proposed for feedback for MBS messages.

In a first solution, when a network device is going to transmit unicast service and multicast service, the network device first configure control channel resources specific to a terminal device for the terminal device to use to transmit acknowledgment feedback. Then, the terminal device receives, from the network device, first downlink control information (DCI) scheduling transmission of a unicast data message and second DCI scheduling transmission of a multicast data message. To feed back whether the these messages are correct, the terminal device transmit HARQ-ACK codebook to the network device on the configured control channel resources. The HARQ-ACK codebook contains the first acknowledgment information in response to monitoring for the unicast data message and the second acknowledgment information in response to monitoring for the unicast data message. decoding or not

The first solution only implements how to determine the Physical Uplink Control Channel (PUCCH) resource, but it does not design how to determine the codebook.

In a second solution, the terminal device determines a set of Transmission Time Intervals (TTIs) associated with an occasion for uplink acknowledgment feedback. The set of TTIs includes at least a first TTI allocated for unicast downlink data for the UE and at least a second TTI allocated for multicast downlink data for the terminal device. The terminal device monitors the set of TTIs for the unicast downlink data and the multicast downlink data. The terminal device determines acknowledgment information for the monitored set of TTIs according to an acknowledgment codebook that includes TTIs allocated for unicast downlink data, including the first TTI, and excludes TTIs allocated for multicast downlink data, including the second TTI. Then, the terminal device transmits, in the occasion for uplink acknowledgment feedback, a feedback message including the determined acknowledgment information.

The second solution only implements how to determine the HARQ-ACK feedback windows, but it does not design how to determine the codebook.

In a third solution, to support the FDM-ed unicast and multicast scenarios, the easiest way is to construct the sub-codebook separately for the unicast and multicast services according to respective kl values. In each slot, to make the same understanding for both the network device and the terminal device, the order of Physical Downlink Share Channel (PDSCH) reception can be decided as the principle that the unicast feedback information followed by multicast feedback information. Moreover, the order between multiple MBS Type-1 HARQ-ACK sub-codebooks can be further studied.

The third solution does not discuss how does the terminal device identifies whether a PDSCH occasion should be fed back in the unicast sub-codebook or the multicast sub-codebook.

In order to solve the above technical problem in conventional solutions, embodiments of the present disclosure provide a solution for transmitting HARQ feedback. In this solution, a terminal device transmits, to a network device, at least one HARQ-ACK codebook in a slot. The at least one HARQ-ACK codebook comprises a first feedback for unicast service and a second feedback for MBS. In this way, the network device may obtain a HARQ-ACK codebook containing the feedbacks of both unicast service and MBS.

Embodiments of the present disclosure may be applied to any suitable scenarios. For example, embodiments of the present disclosure may be implemented at URLLC (Ultra-reliable and Low Latency Communication). Alternatively, embodiments of the present disclosure can be implemented in one of the followings: reduced capability NR devices, NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

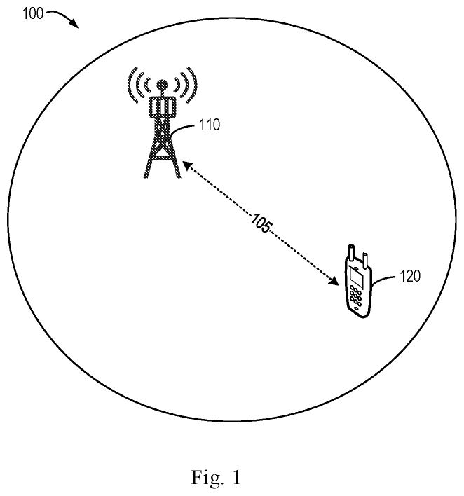

FIG. 1 is a schematic diagram of a communication environment 100 in which some embodiments of the present disclosure can be implemented. As shown in FIG. 1, the communication environment 100, which may also be referred to as a communication network 100, includes a network device 110 serving a terminal device 120. In particular, the terminal device 120 may communicate with the network device 110 via a communication channel 105.

For transmissions from the network device 110 to the terminal device 120, the communication channel 105 may be referred to as a downlink channel. For transmissions from the terminal device 120 to the network device 110, the communication channel 105 may be referred to as an uplink channel.

Although the network device 110 and the terminal device 120 are described in the communication environment 100 of FIG. 1, embodiments of the present disclosure may be equally applicable to any other suitable communication devices in communication with one another. That is, embodiments of the present disclosure are not limited to the example scenario of FIG. 1. In this regard, it is noted that although the terminal device 120 is schematically depicted as mobile phones in FIG. 1, it is understood that this depiction is only for example without suggesting any limitation. In other embodiments, the terminal device 120 may be any other wireless communication devices, for example, vehicle-mounted terminal devices.

It is to be understood that the number of the terminal devices and the number of the network devices as shown in FIG. 1 are only for the purpose of illustration without suggesting any limitations. The communication environment 100 may include any suitable number of terminal devices, any suitable number of network devices, and any suitable number of other communication devices adapted for implementing embodiments of the present disclosure. In addition, it would be appreciated that there may be various wireless communications as well as wireline communications (if needed) among all the communication devices.

The communications in the communication environment 100 may conform to any suitable standards including, but not limited to, Global System for Mobile Communications (GSM), Extended Coverage Global System for Mobile Internet of Things (EC-GSM-IoT), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

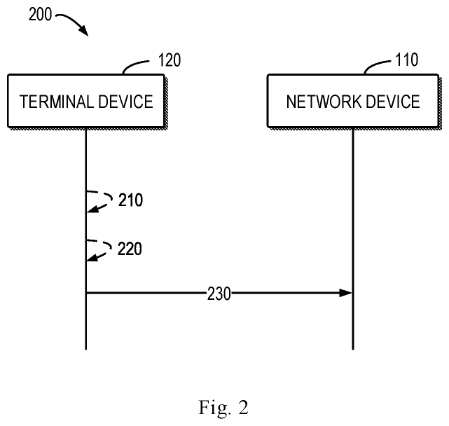

Principle and implementations of the present disclosure will be described in detail below with reference to FIGS. 2 to 8. FIG. 2 illustrates an example signaling chart showing an example process 200 for transmitting HARQ feedback in accordance with some embodiments of the present disclosure. For the purpose of discussion, the communication process 200 will be described with reference to FIG. 1. However, it would be appreciated that the communication process 200 may be equally applicable to other communication scenarios where a network device and a terminal device communicate with each other.

As shown in FIG. 2, the terminal device 120 transmits (230) at least one HARQ-ACK codebook in a slot to the network device 110. The at least one HARQ-ACK codebook comprises a first feedback for unicast service and a second feedback for MBS. In this way, the network device 110 may obtain a HARQ-ACK codebook containing the feedbacks of both unicast service and MBS.

In some embodiments, the terminal device 120 may determine (210) the first feedback for the unicast service based on a first frequency range in which the unicast service is received. The terminal device 120 may determine (220) the second feedback for the MBS based on a second frequency range in which the MBS is received. The second frequency range is different from the first frequency range.

In such embodiments, all the terminal devices in an MBS group may receive group-common PDSCH or Physical Downlink Control Channel (PDCCH) in a specific frequency band (also referred to as the second frequency range). The second frequency range may comprise Common Frequency Resource (CFR) or MBS dedicated Bandwidth Part (BWP). When the terminal device 120 determines the first feedback for the unicast service, the PDSCH occasions that exist in CFR or MBS dedicated BWP should be excluded. Alternatively, when the terminal device 120 determines the second feedback for the MBS, the PDSCH occasions that do not exist in CFR or MBS dedicated BWP should be excluded.

In some embodiments, a dedicated HARQ-ACK codebook for MBS may be configured when the priority index for unicast service and MBS are the same. In other words, separate HARQ-ACK codebooks are constructed for unicast service and MBS. In such embodiments, the terminal device 120 may transmit a first HARQ-ACK codebook for the unicast service and a second HARQ-ACK codebook for the MBS to the network device 110. The first HARQ-ACK codebook comprises the first feedback for the unicast service, and the second HARQ-ACK codebook comprises the second feedback for the MBS. Each of the first and second first feedback may comprise one or more HARQ-ACK bits.

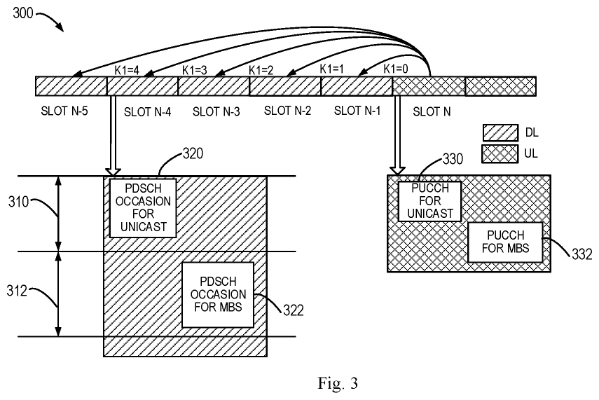

In some embodiments, separate PUCCH Configuration for MBS may be configured. In such embodiments, the network device 110 may configure the terminal device 120 with a first PUCCH configuration for the unicast service and a second PUCCH configuration for the MBS. For example, the network device 110 may transmit each of the first and second PUCCH configurations via a PUCCH-ConfigurationList. Accordingly, the terminal device 120 may receive, from the network device 110, the first PUCCH configuration for the unicast service and the second PUCCH configuration for the MBS. This will be described with reference to FIG. 3.

FIG. 3 illustrates a simplified block diagram of an example process 300 for transmitting HARQ feedback in accordance with some embodiments of the present disclosure. For the purpose of discussion, the example process 300 will be described with reference to FIG. 1. However, it would be appreciated that the example process 300 may be equally applicable to other communication scenarios where a network device and a terminal device communicate with each other.

In the example process 300, the terminal device 120 receives, from the network device 110, the first PUCCH configuration for the unicast service and the second PUCCH configuration for the MBS. The first PUCCH configuration may comprise a first set of HARQ timing values and the second PUCCH configuration may comprise a second set of HARQ timing values. Hereinafter, the first set of HARQ timing values may be referred to as a first K1 set, and the second set of HARQ timing values may be referred to as a second K1 set.

In addition, in the example process 300, the terminal device 120 transmits the first HARQ-ACK codebook for the unicast service and the second HARQ-ACK codebook for the MBS to the network device 110. The first HARQ-ACK codebook comprises the first feedback for the unicast service, and the second HARQ-ACK codebook comprises the second feedback for the MBS.

In the example process 300, the first K1 set may be different from the second K1 set. For example, the first K1 set may be {2, 3, 4}, and the second K1 set may be {0, 1, 2, 3}.

Based on the first K1 set, the terminal device 120 may determine that a HARQ-ACK feedback window for the unicast service comprises slot n-3, slot n-4 and slot n-5. Based on the second K1 set, the terminal device 120 may determine that a HARQ-ACK feedback window for the MBS comprises slot n-1, slot n-2, slot n-3 and slot n-4. Thus, the HARQ-ACK feedback window for the unicast service and the HARQ-ACK feedback window for the MBS overlap in the slot n-3 and slot n-4.

In each of the slot n-3 and slot n-4, PDSCH occasion for the unicast service and PDSCH occasion for the MBS may be time division multiplexed (TMD-ed).

As shown in FIG. 3, PDSCH transmission for the unicast service is received in a first frequency range 310, and PDSCH transmission for the MBS is received in a second frequency range 312. The second frequency range 312 is different from the first frequency range 310.

With respect to each of the slot n-3 and slot n-4, when the terminal device 120 determines the first HARQ-ACK codebook for the unicast service, the terminal device 120 may only consider PDSCH occasion 320 for the unicast service. Similarly, with respect to each of the slot n-3 and slot n-4, when the terminal device 120 determines the second HARQ-ACK codebook for the MBS, the terminal device 120 may only consider PDSCH occasion 322 for the MBS.

With respect to the slot n-5 which only comprises PDSCH occasion for the unicast service, the terminal device 120 may determine a HARQ-ACK bit for the PDSCH occasion for the unicast service based on the conventional method. For example, if the terminal device 120 correctly receives DL transmission in the PDSCH occasion in the slot n-5, the terminal device 120 may determine an ACK for the PDSCH occasion; otherwise, the terminal device 120 may determine a NACK for the PDSCH occasion.

Similarly, with respect to the slot n-1 and slot n-2 which only comprise PDSCH occasions for the MBS, the terminal device 120 may determine HARQ-ACK bits for the PDSCH occasions for the MBS based on the conventional method.

In addition, based on the first PUCCH configuration for the unicast service and a size of the first HARQ-ACK feedback, the terminal device 120 may determine a PUCCH resource 330 for the first HARQ-ACK feedback for the unicast service. Similarly, based on the second PUCCH configuration for the MBS and a size of the second HARQ-ACK feedback, the terminal device 120 may determine a PUCCH resource 332 for the second HARQ-ACK feedback for the MBS.

In the example process 300, the terminal device 120 may construct the first HARQ-ACK codebook that comprises the first feedback for the unicast service, and the second HARQ-ACK codebook that comprises the second feedback for the MBS. In turn, in the slot n, the terminal device 120 may transmit, to the network device 110, the first HARQ-ACK codebook on the PUCCH resource 330, and the second HARQ-ACK codebook on the PUCCH resource 332.

In some embodiments, the second feedback for the MBS may be disabled. In such embodiments, the terminal device 120 may transmit a HARQ-ACK codebook that only comprises the first feedback for the unicast service.

In some embodiments, a shared HARQ-ACK codebook may be constructed for the unicast service and MBS. In such embodiments, the terminal device 120 may transmit a HARQ-ACK codebook for the unicast service and the MBS to the network device 110. The HARQ-ACK codebook comprises the first feedback for the unicast service and the second feedback for the MBS.

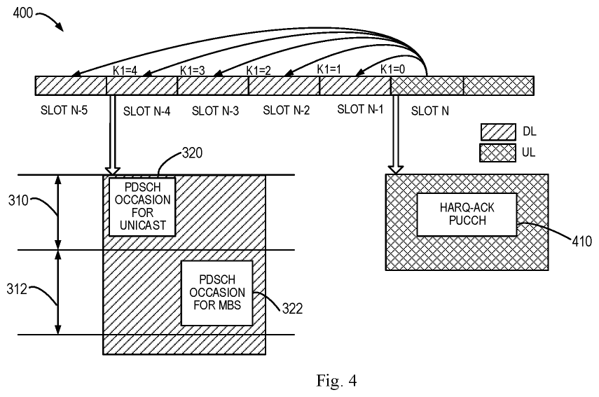

In such embodiments, the terminal device 120 may generate a first sequence of bits for the first feedback for the unicast service, and a second sequence of bits for the second feedback for the MBS. In turn, the terminal device 120 may concatenate the first sequence of bits and the second sequence of bits to generate the HARQ-ACK codebook. For example, in the HARQ-ACK codebook, the first sequence of bits for the unicast service may be followed by the second sequence of bits for the MBS. Alternatively, the second sequence of bits for the MBS may be followed by the first sequence of bits for the unicast service. This will be described with reference to FIG. 4.

FIG. 4 illustrates a simplified block diagram of an example process 400 for transmitting HARQ feedback in accordance with some other embodiments of the present disclosure. For the purpose of discussion, the example process 400 will be described with reference to FIG. 1. However, it would be appreciated that the example process 400 may be equally applicable to other communication scenarios where a network device and a terminal device communicate with each other.

Similar to the example process 300, in the example process 400, the terminal device 120 receives, from the network device 110, the first PUCCH configuration for the unicast service and the second PUCCH configuration for the MBS. The first PUCCH configuration may comprise a first K1 set and the second PUCCH configuration may comprise a second K1 set. In the example process 400, the first K1 set may be {2, 3, 4}, and the second K1 set may be {0, 1, 2, 3}.

Based on the first and second K1 sets, the terminal device 120 may determine that a HARQ-ACK feedback window for the unicast service comprises slot n-3, slot n-4 and slot n-5, and that a HARQ-ACK feedback window for the MBS comprises slot n-1, slot n-2, slot n-3 and slot n-4.

Different from the example process 300, in the example process 400, the terminal device 120 transmits a HARQ-ACK codebook for the unicast service and for the MBS to the network device 110. The HARQ-ACK codebook comprises the first feedback for the unicast service and the second feedback for the MBS.

In order to generate the HARQ-ACK codebook, with respect to the HARQ-ACK feedback window for the unicast service that comprises slot n-3, slot n-4 and slot n-5, the terminal device 120 may generate a first sequence of bits for the first feedback for the unicast service. With respect to the HARQ-ACK feedback window for the MBS that comprises slot n-1, slot n-2, slot n-3 and slot n-4, the terminal device 120 may generate a second sequence of bits for the second feedback for the MBS.

It is to be noted that similar to the example process 300, in the example process 400, with respect to each of the slot n-3 and slot n-4, when the terminal device 120 determines the first HARQ-ACK feedback for the unicast service, the terminal device 120 may only consider PDSCH occasion 320 for the unicast service. Similarly, with respect to each of the slot n-3 and slot n-4, when the terminal device 120 determines the second HARQ-ACK feedback for the MBS, the terminal device 120 may only consider PDSCH occasion 322 for the MBS.

Upon generations of the first and second sequences of bits, the terminal device 120 may concatenate the first sequence of bits and the second sequence of bits to generate the HARQ-ACK codebook.

In the example process 400, the terminal device 120 may receive first downlink control information (DCI) and second DCI from the network device 110. The first DCI indicates a first PUCCH resource for transmission of the first HARQ-ACK feedback. The second DCI indicates a second PUCCH resource for transmission of the second HARQ-ACK feedback. The terminal device 120 may transmit the HARQ-ACK codebook that comprises the first HARQ-ACK feedback and the second HARQ-ACK feedback on a PUCCH resource 410 indicated by one of the first DCI and the second DCI.

For example, the first DCI may indicate a first PUCCH resource by a first PRI field, and the second DCI may indicate a second PUCCH resource by a second PRI field. The terminal device 120 may ignore the first PUCCH resource indicated by the first PRI field in the first DCI. In turn, the terminal device 120 may transmit the HARQ-ACK codebook on the second PUCCH resource indicated by the second PRI field in the second DCI. Alternatively, the terminal device 120 may ignore the second PUCCH resource indicated by the second PRI field in the second DCI. In turn, the terminal device 120 may transmit the HARQ-ACK codebook on the first PUCCH resource indicated by the first PRI field in the first DCI.

In the example process 400, the terminal device 120 constructs the first HARQ-ACK feedback for the unicast service and the second HARQ-ACK feedback for the MBS in a single HARQ-ACK codebook. As such, requirement for the processing capability of the terminal device 120 may be reduced. In addition, a few changes may be made to the current specification.

In addition, similar to the example process 300, in the example process 400, the second feedback for the MBS may be disabled. In such embodiments, the terminal device 120 may transmit a HARQ-ACK codebook that only comprises the first feedback for the unicast service.

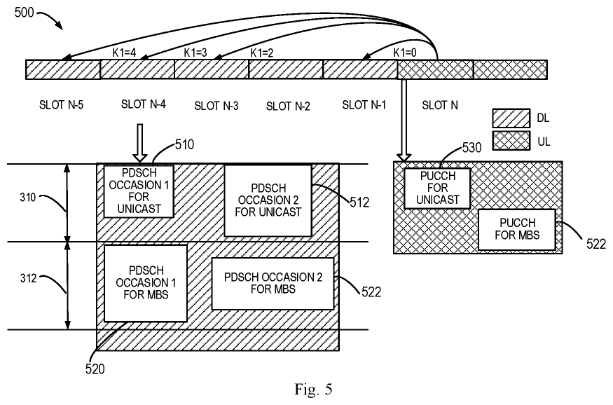

In some embodiments, a shared PUCCH configuration may be configured. In such embodiments, the terminal device 120 may receive, from the network device 110, a PUCCH configuration for the unicast service and the MBS. Then, the terminal device 120 may determine the first and second HARQ-ACK feedbacks based on the PUCCH configuration. This will be described with reference to FIG. 5.

FIG. 5 illustrates a simplified block diagram of an example process 500 for transmitting HARQ feedback in accordance with some other embodiments of the present disclosure. For the purpose of discussion, the example process 500 will be described with reference to FIG. 1. However, it would be appreciated that the example process 500 may be equally applicable to other communication scenarios where a network device and a terminal device communicate with each other.

In the example process 500, the terminal device 120 receives, from the network device 110, a PUCCH configuration for the unicast service and for the MBS. The PUCCH configuration may comprise a K1 set. In the example process 500, the K1 set may be {0, 2, 3, 4}.

Based on the K1 set, the terminal device 120 may determine that a HARQ-ACK feedback window for the unicast service and the MBS comprises n-5, slot n-4, slot n-3 and slot n-1.

In each of the slot n-5, slot n-4, slot n-3 and slot n-1, there are two PDSCH occasions for the unicast service and two PDSCH occasions for the MBS. For example, in the slot n-4, there are PDSCH occasions 510 and 512 for the unicast service and PDSCH occasions 520 and 522 for the MBS.

With respect to the PDSCH occasions for the unicast service in each of the slot n-5, slot n-4, slot n-3 and slot n-1, the terminal device 120 constructs a first HARQ-ACK codebook for the unicast service. With respect to the PDSCH occasions for the MBS in each of the slot n-5, slot n-4, slot n-3 and slot n-1, the terminal device 120 constructs a second HARQ-ACK codebook for the MBS.

When the terminal device 120 constructs the first HARQ-ACK codebook for the unicast service, the terminal device 120 may only consider PDSCH occasions for the unicast service in each of the slot n-5, slot n-4, slot n-3 and slot n-1. Similarly, when the terminal device 120 determines the second HARQ-ACK codebook for the MBS, the terminal device 120 may only consider PDSCH occasions for the MBS in each of the slot n-5, slot n-4, slot n-3 and slot n-1.

In the example process 500, the terminal device 120 may receive first DCI and second DCI from the network device 110. The first DCI indicates a first PUCCH resource 530 for transmission of the first HARQ-ACK codebook. The second DCI indicates a second PUCCH resource 532 for transmission of the second HARQ-ACK codebook. The first PUCCH resource is different from the second PUCCH resource.

In slot n, the terminal device 120 may transmit the first HARQ-ACK codebook for the unicast service on the PUCCH resource 530 indicated by a first PRI in the first DCI, and transmit the second HARQ-ACK codebook for the MBS on the PUCCH resource 532 indicated by a second PRI in the second DCI.

In addition, similar to the example process 300, in the example process 500, the second feedback for the MBS may be disabled. In such embodiments, the terminal device 120 may transmit a HARQ-ACK codebook that only comprises the first feedback for the unicast service.

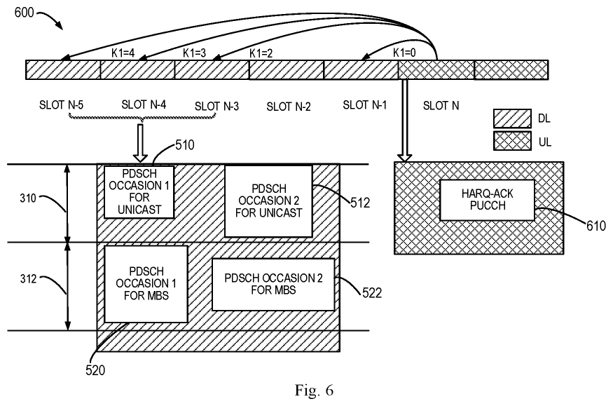

In embodiments where a shared PUCCH configuration is configured for the unicast service and for the MBS, the terminal device 120 may construct a shared HARQ-ACK codebook for the unicast service and for the MBS. This will be described with reference to FIG. 6.

FIG. 6 illustrates a simplified block diagram of an example process 600 for transmitting HARQ feedback in accordance with some other embodiments of the present disclosure. For the purpose of discussion, the example process 600 will be described with reference to FIG. 1. However, it would be appreciated that the example process 600 may be equally applicable to other communication scenarios where a network device and a terminal device communicate with each other.

Similar to the example process 500, in the example process 600, the terminal device 120 receives, from the network device 110, a PUCCH configuration for the unicast service and for the MBS. The PUCCH configuration may comprise a K1 set. In the example process 600, the K1 set may be {0, 2, 3, 4}.

Based on the K1 set, the terminal device 120 may determine that a HARQ-ACK feedback window for the unicast service and the MBS comprises n-5, slot n-4, slot n-3 and slot n-1.

With respect to the PDSCH occasions for the unicast service in each of the slot n-5, slot n-4, slot n-3 and slot n-1, the terminal device 120 generates a first sequence of bits for the first HARQ-ACK feedback for the unicast service. With respect to the PDSCH occasions for the MBS in each of the slot n-5, slot n-4, slot n-3 and slot n-1, the terminal device 120 generates a second sequence of bits for the second HARQ-ACK feedback for the MBS.

When the terminal device 120 generates the first sequence of bits for the unicast service, the terminal device 120 may only consider PDSCH occasions for the unicast service in each of the slot n-5, slot n-4, slot n-3 and slot n-1. Similarly, when the terminal device 120 generates the second sequence of bits for the MBS, the terminal device 120 may only consider PDSCH occasions for the MBS in each of the slot n-5, slot n-4, slot n-3 and slot n-1.

Upon generations of the first and second sequences of bits, the terminal device 120 may concatenate the first sequence of bits and the second sequence of bits to generate the HARQ-ACK codebook.

Similar to the example process 400, in the example process 600, the terminal device 120 may receive first DCI and second DCI from the network device 110. The first DCI indicates a first PUCCH resource for transmission of the first HARQ-ACK codebook. The second DCI indicates a second PUCCH resource for transmission of the second HARQ-ACK codebook. The first PUCCH resource is different from the second PUCCH resource. The terminal device 120 may transmit the HARQ-ACK codebook that comprises the first HARQ-ACK feedback and the second HARQ-ACK feedback on a PUCCH resource indicated by one of the first DCI and the second DCI.

For example, the first DCI may indicate the first PUCCH resource by a first PRI field, and the second DCI may indicate the second PUCCH resource by a second PRI field. The terminal device 120 may ignore the first PUCCH resource indicated by the first PRI field in the first DCI. In turn, the terminal device 120 may transmit the HARQ-ACK codebook on the second PUCCH resource indicated by the second PRI field in the second DCI. Alternatively, the terminal device 120 may ignore the second PUCCH resource indicated by the second PRI field in the second DCI. In turn, the terminal device 120 may transmit the HARQ-ACK codebook on the first PUCCH resource indicated by the first PRI field in the first DCI. In the example process 600, the terminal device 120 may transmit the HARQ-ACK codebook that comprises the first HARQ-ACK feedback and the second HARQ-ACK feedback on a PUCCH resource 610 indicated by one of the first and second PRI.

Moreover, following aspects may be applied to embodiments of the present disclosure.

The signaling for (Ultra-reliable and Low Latency Communication, URLLC) feature can be reused to configure separate codebooks for unicast and multicast, respectively, at least for the case of different priorities, at least for Type-2 HARQ codebook.

For time division multiplied unicast and multicast, for Type-1 HARQ-ACK codebook construction for ACK/NACK-based unicast and multicast to be multiplexed in the same PUCCH resource, determining PDSCH reception candidate occasions is based on down-selecting one of the two alternatives as follows.

In one alternative, for slot timing values K1 in the intersection of K1 set for unicast (termed set A) and K1 et for multicast (termed set B), PDSCH reception candidate occasions are determined based on union of the PDSCH TDRA sets. For slot timing values K1 in set A but not in set B, PDSCH reception candidate occasions are determined based on PDSCH TDRA set for unicast. For slot timing values K1 in set B but not in set A, based on PDSCH TDRA set for multicast.

In another alternative, for slot timing values K1 in the union of K1 set for unicast and K1 set for multicast, based on the union of the PDSCH TDRA sets.

NR supports at least the following cases for a terminal device supporting multicast.

The terminal device supports two non-overlapping slot-based PUCCHs for ACK/NACK based HARQ-ACK feedback for multicast with different priorities in a slot subject to capability of the terminal device.

The terminal device supports two non-overlapping slot-based PUCCHs for ACK/NACK based HARQ-ACK feedback for multicast and unicast with different priorities, respectively, in a slot subject to capability of the terminal device.

For Type-1 HARQ-ACK codebook construction for FDM-ed unicast and multicast with the same priority from the same TRP, support the following.

HARQ-ACK bits for all the PDSCH occasions over all the slots for all serving cells for unicast, precede, HARQ-ACK bits for all the PDSCH occasions over all the slots for all serving cells for multicast. This is similar to the joint Type-1 codebook for mTRP.

Otherwise, the terminal device does not expect unicast and multicast are to be scheduled in FDM-ed.

For a separate PUCCH-ConfigurationList for multicast that is optionally configured, at least for ACK/NACK based HARQ-ACK feedback, the separate PUCCH-ConfigurationList for multicast configuration can be a list which includes up to 2 PUCCH-Config configurations corresponding low priority codebook and high priority codebook, respectively.

For multicast of the terminal devices in RRC_CONNECTED mode, a common frequency resource for group-common PDCCH/PDSCH is confined within the frequency resource of a dedicated unicast BWP to support simultaneous reception of unicast and multicast in the same slot.

The terminal device may down select from the following two options for the common frequency resource for group-common PDCCH/PDSCH.

Option 2A: the common frequency resource is defined as an MBS specific BWP, which is associated with the dedicated unicast BWP and using the same numerology (SCS and CP)

Option 2B: the common frequency resource is defined as an ‘MBS frequency region’ with a number of contiguous PRBs, which is configured within the dedicated unicast BWP.

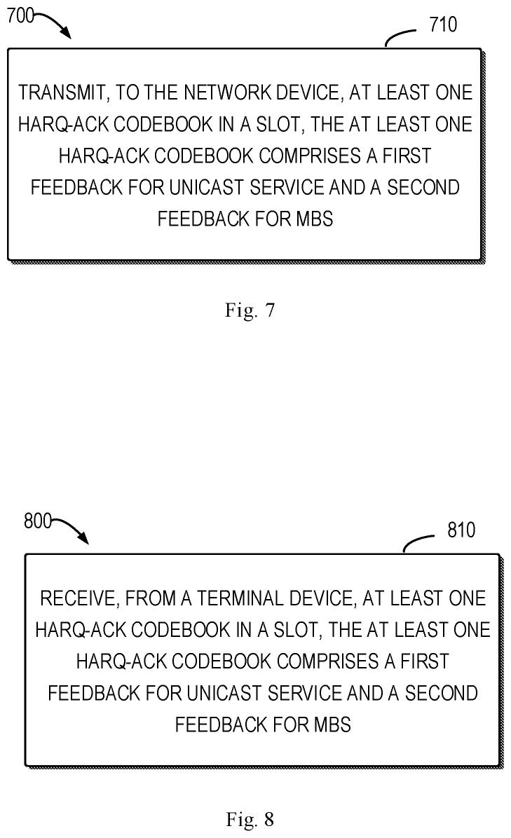

FIG. 7 illustrates a flowchart of an example method 700 in accordance with some embodiments of the present disclosure. In some embodiments, the method 700 can be implemented at a terminal device, such as the terminal device 120 as shown in FIG. 1. For the purpose of discussion, the method 700 will be described with reference to FIG. 1 as performed by the terminal device 120 without loss of generality.

At block 710, the terminal device 120 transmits, to the network device 110, at least one HARQ-ACK codebook in a slot. The at least one HARQ-ACK codebook comprises a first feedback for unicast service and a second feedback for MBS.

In some embodiments, additionally, the terminal device 120 may determine the first feedback for the unicast service based on a first frequency range in which the unicast service is received. Furthermore, the terminal device 120 may determine the second feedback for the MBS based on a second frequency range in which the MBS is received. The second frequency range is different from the first frequency range.

In some embodiments, alternatively, the terminal device 120 may transmit a first HARQ-ACK codebook and a second HARQ-ACK codebook. The first HARQ-ACK codebook comprises the first feedback for the unicast service, and the second HARQ-ACK codebook comprises the second feedback for the MBS.

In some embodiments, alternatively, the terminal device 120 may transmit a HARQ-ACK codebook.

In some embodiments, additionally, the terminal device 120 may generate a first sequence of bits for the first feedback for the unicast service and a second sequence of bits for the second feedback for the MBS. In turn, the terminal device 120 may concatenate the first sequence of bits and the second sequence of bits to generate the HARQ-ACK codebook.

In some embodiments, additionally, the terminal device 120 may receive, from the network device 110, a first PUCCH configuration for the unicast service and a second PUCCH configuration for the MBS. The terminal device 120 may determine the first HARQ-ACK feedback based on the first PUCCH configuration and the second HARQ-ACK feedback based on the second PUCCH configuration.

In some embodiments, additionally, the terminal device 120 may receive, from the network device 110, a PUCCH configuration for the unicast service and the MBS. In turn, the terminal device 120 may determine the first and second HARQ-ACK feedbacks based on the PUCCH configuration.

In some embodiments, additionally, the terminal device 120 may receive first DCI and second DCI from the network device 110. The first DCI indicates a first PUCCH resource for transmission of the first HARQ-ACK feedback. The second DCI indicates a second PUCCH resource for transmission of the second HARQ-ACK feedback. The terminal device 120 may transmit the HARQ-ACK codebook that comprises the first HARQ-ACK feedback and the second HARQ-ACK feedback on a PUCCH resource indicated by one of the first DCI and the second DCI.

In some embodiments, alternatively, the first DCI indicates a first PUCCH resource by a first PRI field, and the second DCI indicates a second PUCCH resource by a second PRI field. The terminal device 120 may ignore the first PUCCH resource indicated by the first PRI field in the first DCI and transmit the HARQ-ACK codebook on the second PUCCH resource indicated by the second PRI field in the second DCI.

In some embodiments, alternatively, the first DCI indicates a first PUCCH resource by a first PRI field, and the second DCI indicates a second PUCCH resource by a second PRI field. The terminal device 120 may ignore the second PUCCH resource indicated by the second PRI field in the second DCI and transmit the HARQ-ACK codebook on the first PUCCH resource indicated by the first PRI field in the first DCI.

In some embodiments, additionally, if the terminal device 120 determines that the second feedback for the MBS is disabled, the terminal device 120 generates the at least one HARQ-ACK codebook that only comprises the first feedback for the unicast service.

FIG. 8 illustrates a flowchart of an example method 800 in accordance with some embodiments of the present disclosure. In some embodiments, the method 800 can be implemented at a terminal device, such as the network device 110 as shown in FIG. 1. For the purpose of discussion, the method 800 will be described with reference to FIG. 1 as performed by the network device 110 without loss of generality.

At block 810, the network device 110 receives, from the terminal device 120, at least one HARQ-ACK codebook in a slot. The at least one HARQ-ACK codebook comprises a first feedback for unicast service and a second feedback for MBS.

In some embodiments, alternatively, the first feedback for the unicast service is determined based on a first frequency range in which the unicast service is received, and the second feedback for the MBS is determined based on a second frequency range in which the MBS is received. The second frequency range is different from the first frequency range.

In some embodiments, alternatively, the network device 110 may receive a first HARQ-ACK codebook and a second HARQ-ACK codebook. The first HARQ-ACK codebook comprises the first feedback for the unicast service, and the second HARQ-ACK codebook comprises the second feedback for the MBS.

In some embodiments, alternatively, the network device 110 may receive a HARQ-ACK codebook.

In some embodiments, alternatively, the HARQ-ACK codebook comprises a first sequence of bits for the first feedback for the unicast service and a second sequence of bits for the second feedback for the MBS.

In some embodiments, additionally, the network device 110 may transmit, to the terminal device 120, a first PUCCH configuration for the unicast service and a second PUCCH configuration for the MBS. The first HARQ-ACK feedback is determined based on the first PUCCH configuration, and the second HARQ-ACK feedback is determined based on the second PUCCH configuration.

In some embodiments, additionally, the network device 110 may transmit, to the terminal device 110, a PUCCH configuration for the unicast service and the MBS. The first and second HARQ-ACK feedbacks are determined based on the PUCCH configuration.

In some embodiments, additionally, the network device 110 may transmit first DCI and second DCI to the terminal device. The first DCI indicates a first resource for transmission of the first HARQ-ACK feedback. The second DCI indicates a second resource for transmission of the second HARQ-ACK feedback. The network device 110 may receive the at least one HARQ-ACK codebook on one of the first and second resources.

In some embodiments, alternatively, the second feedback for the MBS is disabled, and the at least one HARQ-ACK codebook only comprises the first feedback for the unicast service.

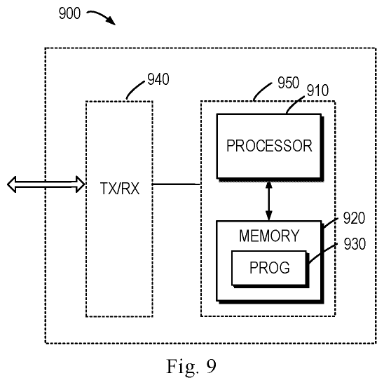

FIG. 9 is a simplified block diagram of a device 900 that is suitable for implementing some embodiments of the present disclosure. The device 900 can be considered as a further example embodiment of the network device 110 or the terminal device 120 as shown in FIG. 1. Accordingly, the device 900 can be implemented at or as at least a part of the network device 110 or the terminal device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 920 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 930 is assumed to include program instructions that, when executed by the associated processor 910, enable the device 900 to operate in accordance with the embodiments of the present disclosure, as discussed herein with reference to FIGS. 2 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 3 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method for communications, comprising:
transmitting, from a terminal device to a network device, at least one Hybrid Automatic Repeat Request Acknowledge, HARQ-ACK, codebook in a slot, the at least one HARQ-ACK codebook comprising a first feedback for unicast service and a second feedback for Multicast and Broadcast Service, MBS.

2. The method of claim 1, further comprising:
determining the first feedback for the unicast service based on a first frequency range in which the unicast service is received; and
determining the second feedback for the MBS based on a second frequency range in which the MBS is received, the second frequency range being different from the first frequency range.

3. The method of claim 1, wherein transmitting the at least one HARQ-ACK codebook comprises:
transmitting a first HARQ-ACK codebook and a second HARQ-ACK codebook, the first HARQ-ACK codebook comprising the first feedback for the unicast service, and the second HARQ-ACK codebook comprising the second feedback for the MBS.

4. The method of claim 1, wherein transmitting the at least one HARQ-ACK codebook comprises:
transmitting a HARQ-ACK codebook.

5. The method of claim 4, further comprising:
generating the HARQ-ACK codebook by:
generating a first sequence of bits for the first feedback for the unicast service;
generating a second sequence of bits for the second feedback for the MBS; and
concatenating the first sequence of bits and the second sequence of bits.

6. The method of claim 3, further comprising:
receiving, from the network device, a first Physical Uplink Control Channel, PUCCH, configuration for the unicast service;
receiving, from the network device, a second PUCCH configuration for the MBS;
determining the first HARQ-ACK feedback based on the first PUCCH configuration; and
determining the second HARQ-ACK feedback based on the second PUCCH configuration.

7. The method of claim 3, further comprising:
receiving, from the network device, a Physical Uplink Control Channel, PUCCH, configuration for the unicast service and the MBS; and
determining the first and second HARQ-ACK feedbacks based on the PUCCH configuration.

8. The method of claim 4, further comprising:
receiving first downlink control information, DCI, from the network device, the first DCI indicating a first Physical Uplink Control Channel, PUCCH, resource for transmission of the first HARQ-ACK feedback; and
receiving second DCI from the network device, the second DCI indicating a second PUCCH resource for transmission of the second HARQ-ACK feedback; and
wherein transmitting the HARQ-ACK codebook comprises:
transmitting the HARQ-ACK codebook that comprises the first HARQ-ACK feedback and the second HARQ-ACK feedback on a PUCCH resource indicated by one of the first DCI and the second DCI.

9. The method of claim 8, wherein the first DCI indicates a first PUCCH resource by a first PRI field, and the second DCI indicates a second PUCCH resource by a second PRI field; and
wherein transmitting the HARQ-ACK codebook comprises:
ignoring the first PUCCH resource indicated by the first PRI field in the first DCI; and
transmitting the HARQ-ACK codebook on the second PUCCH resource indicated by the second PRI field in the second DCI.

10. The method of claim 8, wherein the first DCI indicates a first PUCCH resource by a first PRI field, and the second DCI indicates a second PUCCH resource by a second PRI field; and
wherein transmitting the HARQ-ACK codebook comprises:
ignoring the second PUCCH resource indicated by the second PRI field in the second DCI; and
transmitting the HARQ-ACK codebook on the first PUCCH resource indicated by the first PRI field in the first DCI.

11. The method of claim 1, further comprising:
in accordance with a determination that the second feedback for the MBS is disabled, generating the at least one HARQ-ACK codebook that only comprises the first feedback for the unicast service.

12. A method for communications, comprising:
receiving, at a network device and from a terminal device, at least one Hybrid Automatic Repeat Request Acknowledge, HARQ-ACK, codebook in a slot, the at least one HARQ-ACK codebook comprising a first feedback for unicast service and a second feedback for Multicast and Broadcast Service, MBS.

13. (canceled)

14. The method of claim 12, wherein receiving the at least one HARQ-ACK codebook comprises:
receiving a first HARQ-ACK codebook and a second HARQ-ACK codebook, the first HARQ-ACK codebook comprising the first feedback for the unicast service, and the second HARQ-ACK codebook comprising the second feedback for the MBS.

15. The method of claim 12, wherein receiving the at least one HARQ-ACK codebook comprises:
receiving a HARQ-ACK codebook.

16. The method of claim 15, wherein the HARQ-ACK codebook comprises a first sequence of bits for the first feedback for the unicast service and a second sequence of bits for the second feedback for the MBS.

17. The method of claim 14, further comprising:
transmitting, to the terminal device, a first Physical Uplink Control Channel, PUCCH, configuration for the unicast service;
transmitting, to the terminal device, a second PUCCH configuration for the MBS;
wherein the first HARQ-ACK feedback is determined based on the first PUCCH configuration, and the second HARQ-ACK feedback is determined based on the second PUCCH configuration.

18. The method of claim 14, further comprising:
transmitting, to the terminal device, a Physical Uplink Control Channel, PUCCH, configuration for the unicast service and the MBS; and
wherein the first and second HARQ-ACK feedbacks are determined based on the PUCCH configuration.

19. The method of claim 15, further comprising:
transmitting first downlink control information, DCI, to the terminal device, the first DCI indicating a first resource for transmission of the first HARQ-ACK feedback; and
transmitting second DCI to the terminal device, the second DCI indicating a second resource for transmission of the second HARQ-ACK feedback; and
wherein receiving the at least one HARQ-ACK codebook comprises:
receiving the at least one HARQ-ACK codebook on one of the first and second resources.

20. The method of claim 12, wherein the second feedback for the MBS is disabled, and the at least one HARQ-ACK codebook only comprises the first feedback for the unicast service.

21. A terminal device, comprising:
a processor; and
a memory coupled to the processor and storing instructions thereon, the instructions, when executed by the processor, causing the terminal device to perform the method according to claim 1.

22-24. (canceled)
